(19) United States
(12) Patent Application Publication
(10) Pub. No.: US 2020/0318389 A1
(43) Pub. Date: Oct. 8, 2020

(54) COMBINATION LOCK

(71) Applicant: ABRAFOX INC, DULUTH, GA (US)

(72) Inventor: YUE HONG LUO, Guangzhou (CN)

(21) Appl. No.: 16/376,633

(22) Filed: Apr. 5, 2019

(51) Int. Cl. E05B 35/10; E05B 37/00; E05B 37/02

(52) U.S. Cl. CPC E05B 35/105; E05B 37/025; E05B 37/0034

(57) ABSTRACT

A combination lock comprises a lock body, a key lock assembly and a digital combination lock assembly, wherein the key lock assembly includes a lock cylinder and a locking hook sleeve, the lock body is internally provided with an indicating rod and a slider, a first inclined surface is disposed at the bottom of the indicating rod, and the slider is provided with a second inclined surface and a third inclined surface; the locking hook sleeve is provided with a fourth inclined surface; and the lock body is provided with an indicating hole, and the indicating rod can protrude upward from the lock body under the pushing action of the slider. Whether the lock has been unlocked can be judged by the indicating rod.

### FIELD OF THE INVENTION

The invention relates to the technical field of locks, and particularly to a combination lock.

### BACKGROUND OF THE INVENTION

At present, a luggage case or suitcase generally needs to be locked with a lock during consignment, but when the luggage case is passed through the customs, once customs officers find suspicious items in the luggage case or suitcase, the customs officers can forcibly unlock the luggage case or suitcase under the authorization of the government to check the suspicious items therein. However, the lock is discarded after having been forcibly unlocked, such that the damaged lock will cause loss and trouble to an owner, resulting in a lot of inconvenience especially during a journey.

In order to overcome the above disadvantages, customs officers suggested that a lock manufacturer should provide the customs officers with a standard master key that could unlock all the locks manufactured by the manufacturer. Many lock manufacturers around the world then began to obtain authorization to manufacture such locks. This lock structure comprises a lock body, a locking hook, a key lock assembly and a combination lock assembly, and the lock can be unlocked or locked by a key and a code. When customs officers find suspicious items in a luggage case or suitcase, the customs officers can unlock the lock by a standard master key provided by a lock manufacturer to check the suspicious items in the luggage case or suitcase. If no prohibited items are found, the lock is locked again to avoid its damage, which does not cause unnecessary loss to an owner of the lock. However, due to a larger number of luggage cases or suitcases, customs officers cannot remember which luggage cases or suitcase have been checked, which may result in missed or repeated inspection and cause inspection inconvenience to the customs officers.

### SUMMARY OF THE INVENTION

An object of the invention is to provide a combination lock that enables a customs officer to identify whether the lock has been unlocked, thus avoiding the problem of missed or repeated inspection.

To achieve the above object, the invention employs the following technical solution: the combination lock comprises a lock body, a locking hook, a key lock assembly and a digital combination lock assembly, wherein the key lock assembly includes a lock cylinder, a spiral sleeve and a locking hook sleeve, the locking hook sleeve is provided with a locking hole matching the locking hook, the combination lock assembly includes a combination lock ring, a code adjustment ring and an elastic piece, the lock body is also internally provided with an indicating rod and a slider, a first inclined surface is disposed at the bottom of the indicating rod, and the slider is provided with a second inclined surface and a third inclined surface; the second inclined surface can be pushed against the first inclined surface when the slider moves rightward; the locking hook sleeve is provided with a fourth inclined surface, and when the locking hook sleeve moves downward, the fourth inclined surface can be pushed against the third inclined surface so that the slider moves rightward; the lock body is provided with an indicating hole, and the indicating rod can protrude upward from the lock body under the pushing action of the slider; and one end of the locking hook is elastically inserted into the code adjustment ring, the locking hook is provided with a pushing protrusion at a portion thereof which is exposed outside the code adjustment ring, and the pushing protrusion can push the slider to move rightward to be reset when the locking hook is unlocked by a code and lifted upward.

Further, the lock body is internally provided with a spring which is sleeved on the indicating rod, the indicating rod is provided with a step surface, a lower end of the spring abuts against the step surface and an upper end of the spring is tightly pressed against an inner surface of the lock body.

Further, a lower part of the indicating rod is a downwardly opened U-shaped frame, an upper end surface of the U-shaped frame forms the step surface, the U-shaped frame has a horizontally penetrating U-shaped groove and the first inclined surface is disposed at a left side of the U-shaped groove; and the slider is provided with an upwardly opened V-shaped groove, and the second inclined surface is formed by a side wall surface of the V-shaped groove.

Further, an inclined surface is disposed at a left end portion of the slider to form the third inclined surface.

Further, the slider is provided with a supporting portion at a left side of the second inclined surface, the supporting portion is transitionally connected with the second inclined surface, and when the indicating rod is in an indicating state of protruding from the lock body, the supporting portion supports the U-shaped frame to maintain the indicating state.

Further, the locking hook is provided with several spring balls matching the code adjustment ring, and the pushing protrusion is disposed above the uppermost spring ball.

The invention has the following beneficial effects:

when a customs officer unlocks the lock by a key, the locking hook sleeve of the key lock assembly moves downward and pushes the slider to move rightward, and the slider pushes up the indicating rod by the cooperation between the second inclined surface and the first inclined surface, so that one end of the indicating rod is exposed from the surface of the lock body, which functions to mark that the lock has been unlocked, i.e. a luggage case or suitcase locked by the lock has been checked, thus avoiding missed or repeated inspection to facilitate inspection by the customs officer; and after an owner of the lock correctly dials the combination lock ring, the locking hook is lifted up by hand and then the combination lock is unlocked, and the pushing protrusion touches the slider during the uplifting of the locking hook, so that the slider moves leftward and the indicating rod is retracted into the lock body, thus the indicating rod is reset.

### BRIEF DESCRIPTION OF THE DRAWINGS

FIG. 1 is a schematic structural view showing the appearance of the invention;

FIG. 2 is a schematic exploded view of the invention;

FIG. 3 is a schematic structural view of the invention after a rubber sleeve and a surface shell are removed;

FIG. 4 is a schematic structural view of a slider in the invention;

FIG. 5 is a schematic structural view of an indicating rod in the invention; and

FIG. 6 is a schematic structural view of a locking hook sleeve in the invention.

### DESCRIPTION OF CORRESPONDING REFERENCE NUMERALS:

1. lock body; 11. bottom shell; 12. surface shell, 13. indicating hole; 2. locking hook; 21. pushing protrusion; 22. spring balls; 3. key lock assembly; 31. fourth inclined surface; 32. lock cylinder; 33. spiral sleeve; 34. locking hook sleeve; 331. threaded hole; 332. spiral upper cover; 333. spiral lower cover; 341. external thread; 342. locking hole; 3321. fixing hole; 3331. fixing post; 4. digital combination lock assembly; 41. combination lock ring; 42. code adjustment ring; 43. elastic piece; 5. indicating rod; 51. first inclined surface; 52. step surface; 53. U-shaped frame; 6. slider; 61. second inclined surface; 62. third inclined surface; 63. V-shaped groove; 64. guiding block; 65. supporting portion; 7. spring; 8. stop; 9. rubber sleeve.

### DETAILED DESCRIPTION OF THE INVENTION

The technical solutions in the embodiments of the invention will be clearly and completely described below in conjunction with the drawings in the embodiments of the invention.

The embodiment of the combination lock of the invention is as follows:

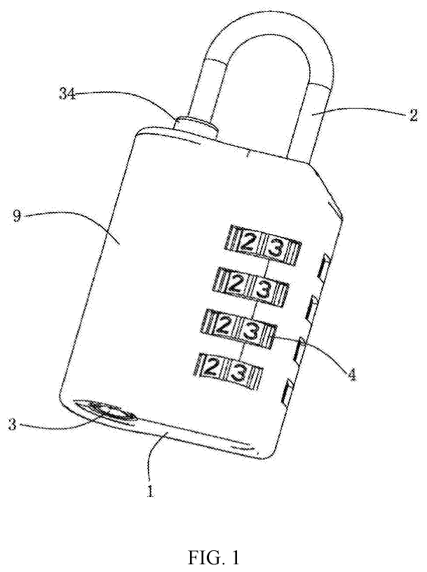

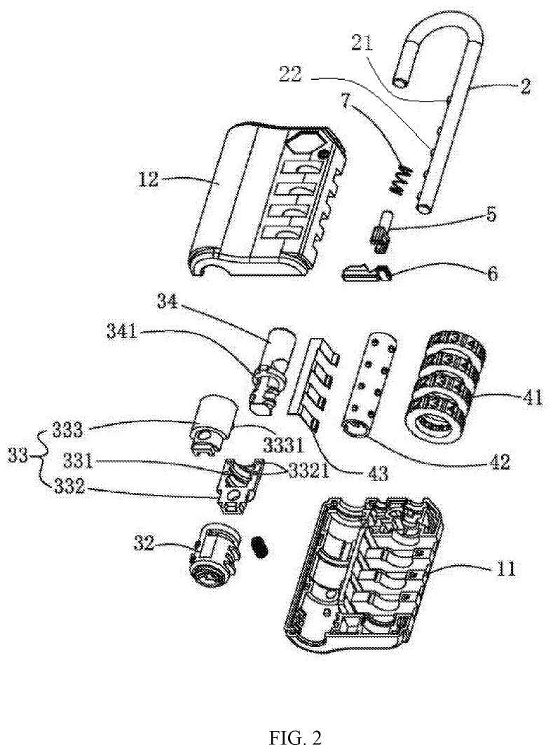

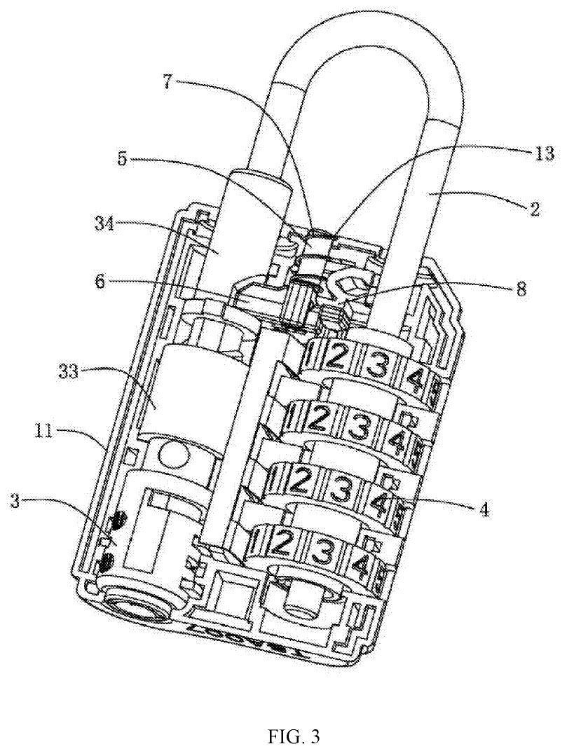

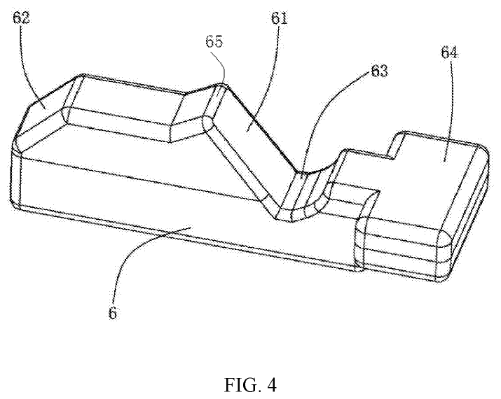

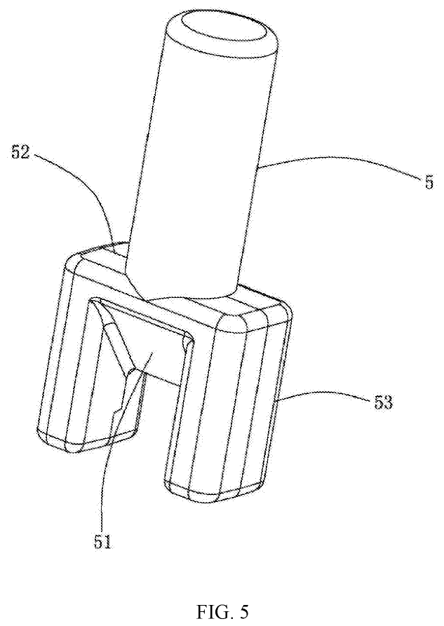

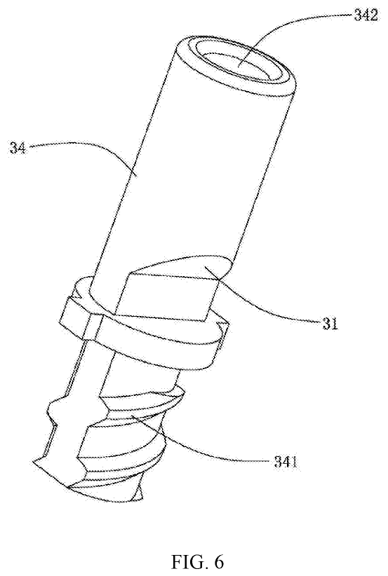

As shown in FIGS. 1 to 6, the combination lock comprises a lock body 1, a locking hook 2, a key lock assembly 3 and a digital combination lock assembly 4, wherein the lock body 1 includes a bottom shell 11 and a surface shell 12, and the key lock assembly 3 includes a lock cylinder 32, a spiral sleeve 33 and a locking hook sleeve 34.

The key lock assembly 3 includes a lock cylinder 32, a spiral sleeve 33 and a locking hook sleeve 34, the spiral sleeve 33 is provided with a threaded hole 331, and the locking hook sleeve 34 is provided with an external thread 341 at one end thereof. One end of the locking hook sleeve 34 at which the external thread 341 is arranged is inserted into the threaded hole 331 of the spiral sleeve 33, the locking hook sleeve 34 is provided with a locking hole 342 matching the locking hook, and one end of the locking hook 2 is inserted into the locking hole 342 when the locking hook 2 is in a locked state.

The spiral sleeve 33 includes a spiral upper cover 332 and a spiral lower cover 333. The spiral upper cover 332 and the spiral lower cover 333 are integrally connected. The spiral upper cover 332 is provided with a fixing hole 3321 on an inner side face thereof, the spiral lower cover 333 is provided with a fixing post 3331 on an inner side face thereof, and the fixing post 3331 is tightly fitted to the fixing hole 3321 when the spiral upper cover 332 is engaged with the spiral lower cover 333.

The digital combination lock assembly 4 includes a plurality of combination lock rings 41, a code adjustment ring 42 and an elastic piece 43, the combination lock rings 41 are sleeved on the code adjustment ring 42, and the elastic piece 43 is connected with the code adjustment ring 42. One end of the locking hook 2 is elastically inserted into the code adjustment ring 42, and the locking hook 2 is provided with a pushing protrusion 21 at a portion thereof which is exposed outside the code adjustment ring. The locking hook 2 is provided with several spring balls 22 matching the code adjustment ring, and the pushing protrusion 21 is disposed above the uppermost spring ball. In this embodiment, there are four spring balls 22 which are correspondingly embedded into spring ball mounting holes on the code adjustment ring, and the spring balls are elastically retractable under force so that the locking hook can be lifted under an external force after the combination lock is opened.

Most of the structures of the key lock assembly 3 and the digital combination lock assembly 4 are based on the prior art, and the invention is an improvement based on the structure of an existing lock.

The lock body 1 is also internally provided with an indicating rod 5 and a slider 6, a first inclined surface 51 is disposed at the bottom of the indicating rod 5, and a lower part of the indicating rod 5 is a downwardly opened U-shaped frame 53. The U-shaped frame 53 has a horizontally penetrating U-shaped groove, and the first inclined surface is disposed at a left side of the bottom of the U-shaped groove.

The slider 6 is provided with a second inclined surface 61 and a third inclined surface 62; and the second inclined surface 61 can be pushed against the first inclined surface 51 when the slider 6 moves rightward. The slider 6 is provided with an upwardly opened V-shaped groove 63, and the second inclined surface 61 is formed by a side wall surface of the V-shaped groove. An inclined surface is disposed at a left end portion of the slider 6 to form the third inclined surface 62.

The locking hook sleeve 34 is provided with a fourth inclined surface 31. When the locking hook sleeve 34 moves downward, the fourth inclined surface 31 can be pushed against the third inclined surface 62 so that the slider 6 moves rightward. The lock body is provided with an indicating hole 13, and the indicating rod 5 can protrude upward from the lock body 1 under the pushing action of the slider 6 and is exposed from the indicating hole 13 to provide a prompting function so that a customs officer can judge whether the lock has been checked based on the indicating rod. When the locking hook is unlocked by a code and lifted upward, the pushing protrusion 21 can push the slider 6 to move rightward to be reset.

The lock body 1 is internally provided with a spring 7 which is sleeved on the indicating rod 5, the indicating rod 5 is provided with a step surface, and an upper end surface of the U-shaped frame 53 forms the step surface 52. A lower end of the spring 7 abuts against the step surface 52 and an upper end of the spring 7 is tightly pressed against an inner surface of the lock body 1. The slider 6 is provided with a supporting portion 65 at a left side of the second inclined surface and the supporting portion 65 is transitionally connected with the second inclined surface 61. When the indicating rod is in an indicating state of protruding from the lock body, the supporting portion supports the U-shaped frame under the applied force of the spring 7 to maintain the indicating state. Only when a leftward external force is applied to the slider 6, the indicating rod 5 can move downward to be reset.

An outer surface of the lock body 1 is covered with a rubber sleeve 9 which can prevent the metal lock body from being eroded.

A guiding block 64 is disposed at one end of the slider 6 far from the locking hook sleeve 34. The bottom shell 11 and the surface shell 12 are respectively provided with stops 8 for keeping the slider 6 moving linearly. When the slider 6 moves, the guiding block 64 moves along a slideway formed between the stop 8 of the bottom shell 11 and the stop 8 of the surface shell 12.

When the combination lock of the invention is used, the operation principle is as follows:

when a customs officer unlocks the lock by a key, the locking hook sleeve 34 of the key lock assembly moves downward and pushes the slider 6 to move rightward, and the slider 6 pushes up the indicating rod 5 by the cooperation between the second inclined surface 61 and the first inclined surface 51, so that one end of the indicating rod 5 is exposed from the surface of the lock body 1; the customs officer locks the combination lock again by the key after inspection, and then the indicating rod is still in an exposed state, prompting the customs officer that the lock has been unlocked, i.e. a luggage case or suitcase locked by the lock has been checked, thus avoiding missed or repeated inspection to facilitate inspection by the customs officer; after an owner of the lock correctly dials the combination lock rings, the locking hook is lifted up by hand and then the combination lock can be unlocked, and the pushing protrusion 21 on the locking hook 2 touches the slider 6 during the uplifting of the locking hook, so that the slider 6 moves leftward, and the indicating rod 5 is retracted into the lock body under the applied force of the spring 7, thus the indicating rod 5 is reset; and during the uplifting of the locking hook, there are two gear positions, i.e. a first gear position in which the lock is unlocked and a second gear position in which the indicating rod is reset.

The invention is not limited to the above most preferred embodiment, and various other forms of products can be obtained by any person under the inspiration of the invention. However, regardless of any change to its shape or structure, any technical solution which is the same as or similar to the present application shall fall into the protection scope of the invention.

1. A combination lock, comprising a lock body, a locking hook, a key lock assembly and a digital combination lock assembly, the key lock assembly including a lock cylinder, a spiral sleeve and a locking hook sleeve, the locking hook sleeve being provided with a locking hole matching the locking hook, and the combination lock assembly including a combination lock ring, a code adjustment ring and an elastic piece, wherein the lock body is also internally provided with an indicating rod and a slider, a first inclined surface is disposed at the bottom of the indicating rod, and the slider is provided with a second inclined surface and a third inclined surface; the second inclined surface can be pushed against the first inclined surface when the slider moves rightward; the locking hook sleeve is provided with a fourth inclined surface, and when the locking hook sleeve moves downward, the fourth inclined surface can be pushed against the third inclined surface so that the slider moves rightward; the lock body is provided with an indicating hole, and the indicating rod can protrude upward from the lock body under the pushing action of the slider; and one end of the locking hook is elastically inserted into the code adjustment ring, the locking hook is provided with a pushing protrusion at a portion thereof which is exposed outside the code adjustment ring, and the pushing protrusion can push the slider to move rightward to be reset when the locking hook is unlocked by a code and lifted upward.

2. The combination lock according to claim 1, wherein the lock body is internally provided with a spring which is sleeved on the indicating rod, the indicating rod is provided with a step surface, a lower end of the spring abuts against the step surface and an upper end of the spring is tightly pressed against an inner surface of the lock body.

3. The combination lock according to claim 2, wherein a lower part of the indicating rod is a downwardly opened U-shaped frame, an upper end surface of the U-shaped frame forms the step surface, the U-shaped frame has a horizontally penetrating U-shaped groove and the first inclined surface is disposed at a left side of the U-shaped groove; and the slider is provided with an upwardly opened V-shaped groove, and the second inclined surface is formed by a side wall surface of the V-shaped groove.

4. The combination lock according to claim 3, wherein an inclined surface is disposed at a left end portion of the slider to form the third inclined surface.

5. The combination lock according to claim 3, wherein the slider is provided with a supporting portion at a left side of the second inclined surface, the supporting portion is transitionally connected with the second inclined surface, and when the indicating rod is in an indicating state of protruding from the lock body, the supporting portion supports the U-shaped frame to maintain the indicating state.

6. The combination lock according to any one of claims 1 to 5, wherein the locking hook is provided with several spring balls matching the code adjustment ring, and the pushing protrusion is disposed above the uppermost spring ball.
